(19) United States
(12) Patent Application Publication
(10) Pub. No.: US 2016/0192637 A1
(43) Pub. Date: Jul. 7, 2016

(54) Hunting Accessory

(71) Applicant: The Hunter Safety System, Inc., Danville, AL (US)

(72) Inventors: Jerry Wydner, Arley, AL (US); John Wydner, Danville, AL (US)

(21) Appl. No.: 14/591,143

(22) Filed: Jan. 7, 2015

(51) Int. Cl. A01M 31/00; A01M 99/00; F16M 13/02

(52) U.S. Cl. CPC A01M 31/00; F16M 13/022; A01M 99/00

(57) ABSTRACT

The present disclosure provides a hunting accessory comprising a plurality of arms, each arm with an upper and lower surface further comprising: one or more knobs and one or more depressions on the upper surface and one or more ridges on the lower surface; an upwardly angled end opposite an attachment point, said attachment point further comprising a central opening, and wherein the plurality of arms comprise at least one aim located between two (2) other arms, said arm further comprising a cavity for receiving a screw, said screw comprising a central screw opening; and a bolt passing through the plurality of arms' central opening and the central screw opening; wherein the plurality of arms are independently rotatable three hundred sixty (360) degrees about an axis passing vertically through the bolt.

### FIELD OF THE INVENTION

The invention relates generally to a device useful while hunting or camping and more specifically relates to a device particularly useful while hunting from a tree stand.

### BACKGROUND ART

Hunters often carry a multitude of accessories on their hunt, including binoculars, backpack, canteens, game calls, rattling antlers, clothing, a gun or a bow. Hunters may carry some of these articles over their shoulder or in a backpack while they are travelling to their hunting location (such as a tree stand), but once arriving at the tree stand and climbing into the tree stand, the hunter will often need quick and easy access to the articles—for example, a hunter may need quick access to their rattling antlers to lure a buck closer to the hunter.

To hang accessories, some hunters currently use a single hook having a threaded end and screwed into a tree. However, if the hunter wants to hang multiple accessories, multiple hooks are required. Other accessories used by some hunters include two elongated bars, often over 12 inches long, connected at a pivot point, with one of the elongated bars having a threaded end, or a screw, to be secured to the tree. In this instance, one bar extends outward from the tree, often over 12 inches, and the second elongated bar can pivot to place the end of the second bar in various positions. However, these devices can be heavy and bulky, and when extended and weighted down, can create a significant momentum arm for the screw in the tree. In both of these prior art accessories, the screw tip can be sharp and cause injury to a person or damage to clothing or a backpack in which the accessories are carried.

The present invention provides a small, compact and easy to use hunting accessory that can be secured to a tree or other secure object near the hunter's tree stand, with minimal damage to the tree or other secure object, that allows the hunter to suspend (or hang) various articles from the hunting accessory and maintain quick and easy access thereto. The present invention also provides a safer alternative to the prior art devices by protecting the user and their clothing/backpacks from the sharp screw tip when not in use.

### SUMMARY OF THE INVENTION

In view of the foregoing shortcomings inherent in the conventional type of methods and systems now present in the prior art, the present invention provides a hunting accessory that is reversibly attachable to a tree (or other wooden object) and has a plurality of independently movable aims that rotate around a central axis.

In one embodiment, the hunting accessory comprises a plurality of arms, each arm with an upper and lower surface further comprising: one or more knobs and one or more depressions on the upper surface and one or more ridges on the lower surface; an upwardly angled end opposite an attachment point, said attachment point further comprising a central opening, and wherein the plurality of arms comprise at least one arm located between two (2) other arms, said arm further comprising a cavity for receiving a screw, said screw comprising a central screw opening; and a bolt passing through the plurality of arms' central opening and the central screw opening; wherein the plurality of arms are independently rotatable three hundred sixty (360) degrees about an axis passing vertically through the bolt.

In one additional embodiment, the hunting accessory comprises one or more arms having a central opening that are rotatable about a vertical axis of the central opening; a screw having a central screw opening and independently rotatable about the vertical axis from the one or more arms; and a securing mechanism passing through the one or more arms central opening and central screw opening.

In one additional embodiment, the hunting accessory comprises a plurality of arms comprising: an angled end opposite an attachment point, said attachment point further comprising a central opening, wherein at least one arm comprises a cavity for receiving a screw, said screw comprising a central screw opening; and a securing mechanism passing through the plurality of arms' central opening and the central screw opening wherein the plurality of arms are independently rotatable about an axis passing vertically through the securing mechanism.

Other objects and advantages of the present invention will become obvious to the reader and it is intended that these objects and advantages are within the scope of the present invention.

To the accomplishment of the above and related objects, this invention may be embodied in the form illustrated in the accompanying drawings/pictures, recognizing however, that the drawings are illustrative only, and that changes may be made in the specific construction illustrated and described within the scope of the appended claims.

### BRIEF DESCRIPTION OF DRAWINGS

It should be noted that identical features in different drawings are shown with the same reference numeral. Various other objects, features and attendant advantages of the present invention will become fully appreciated as the same becomes better understood when considered in conjunction with the accompanying drawings.

FIG. 1 is a front perspective view of one embodiment of the hunting accessory.

FIG. 2 is an alternate front perspective view of one embodiment of the hunting accessory with the screw moved outside of the screw cavity.

FIG. 3 is an alternate front perspective view of one embodiment of the hunting accessory.

FIG. 4 is yet another alternate front perspective view of one embodiment of the hunting accessory.

FIG. 5 is a side view of one embodiment of the hunting accessory.

FIG. 6 is a top view of one embodiment of the hunting accessory with the arms extended.

FIG. 7 is a top view of one embodiment of the hunting accessory with the screw moved outside of the cavity.

FIG. 8 is a bottom view of one embodiment the hunting accessory with the screw moved outside of the cavity.

FIG. 9 is an end view of one embodiment of the hunting accessory.

FIG. 10 is the opposite end view of one embodiment of the hunting shown in FIG.

9.

FIGS. 11a-11c are alternate side and top views of the central arm of one embodiment of the hunting accessory.

FIGS. 12a-12b are side and top views of the outer arms of one embodiment of the hunting accessory.

FIGS. 13a-13b are side and top views of one embodiment of the screw.

### DETAILED DESCRIPTION

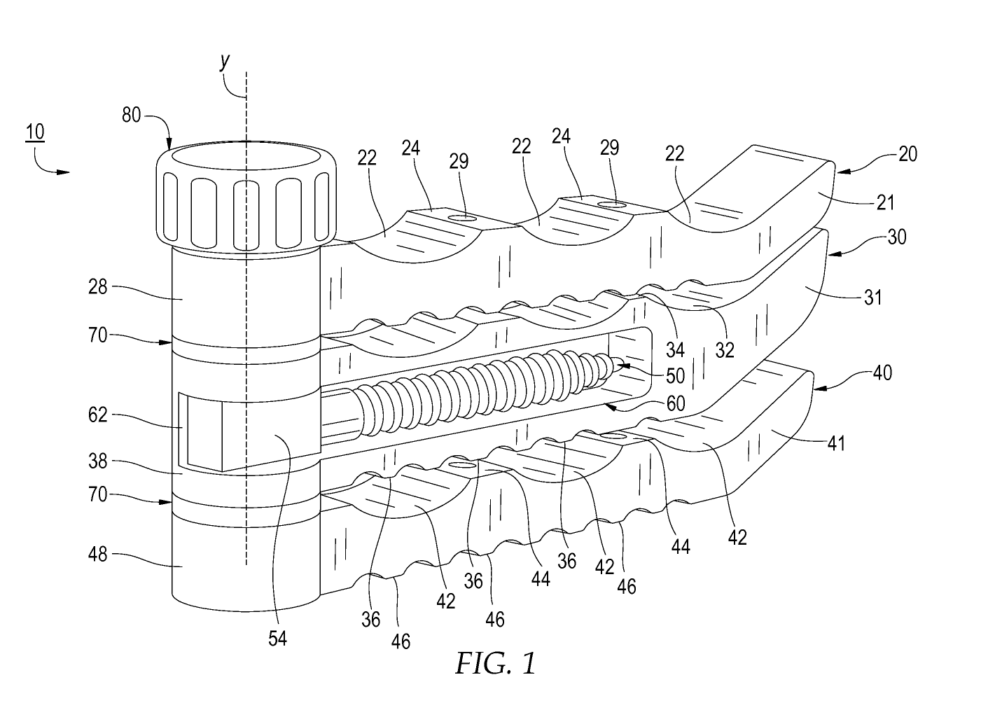

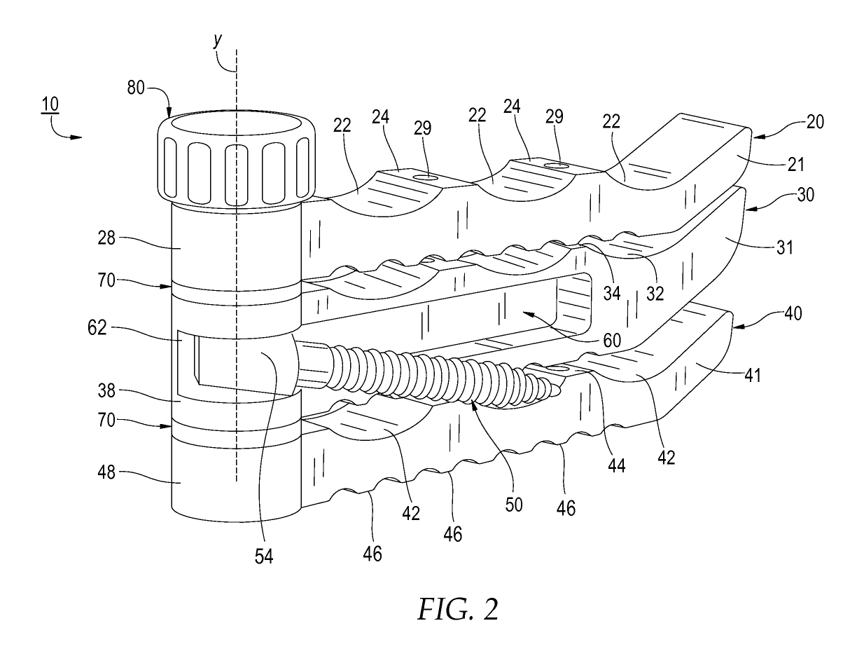

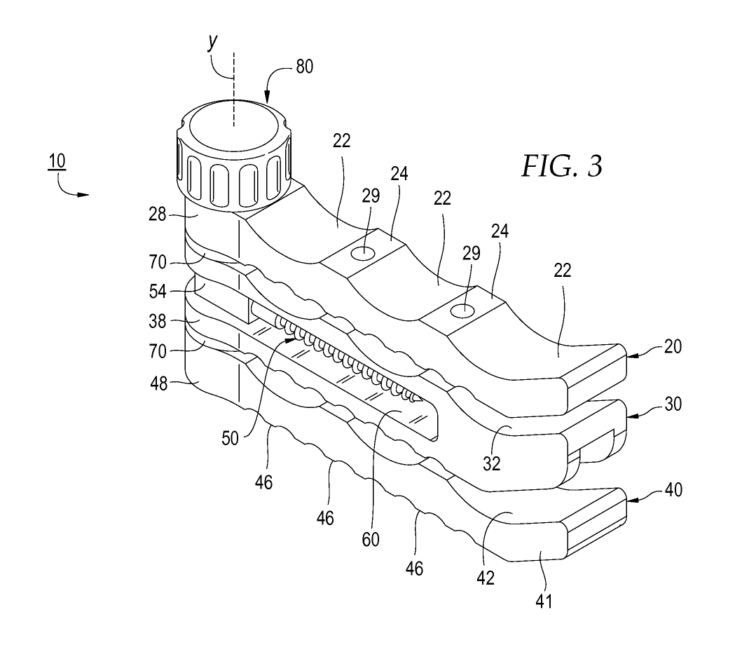

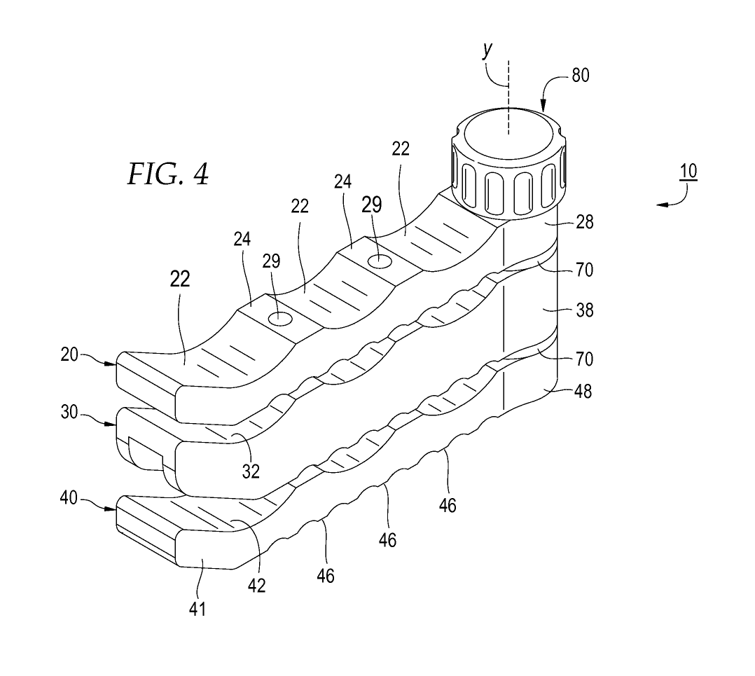

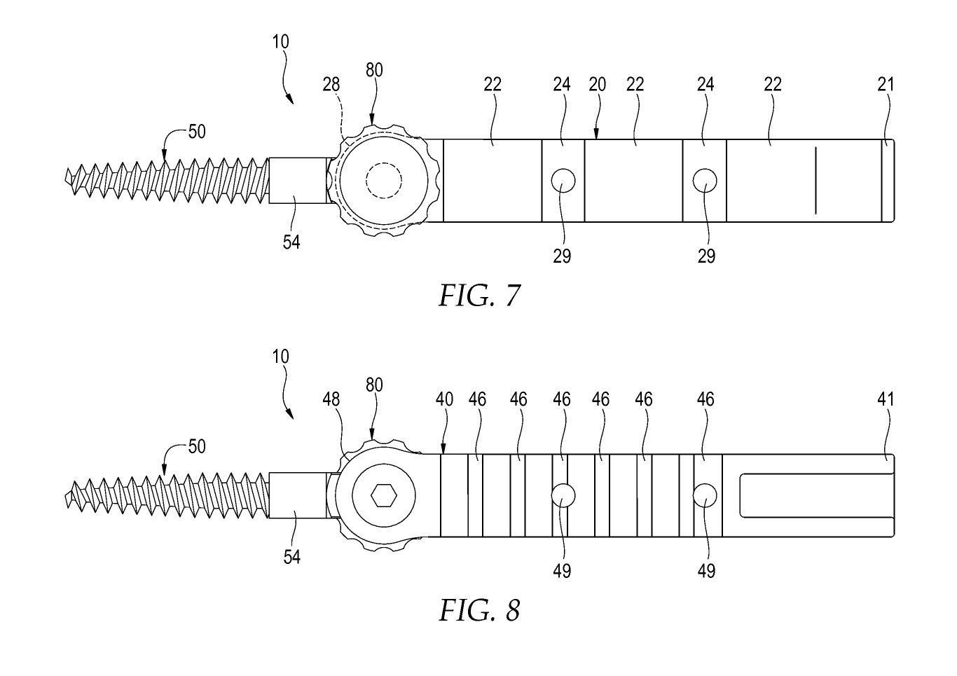

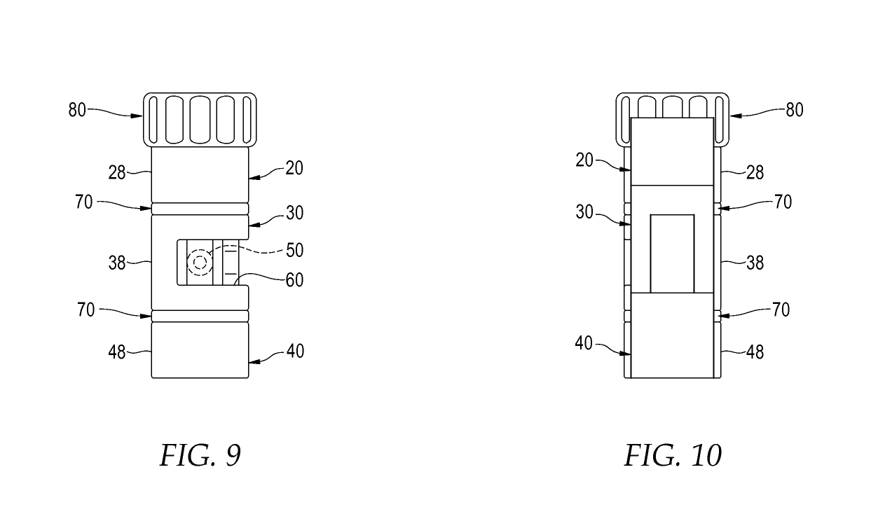

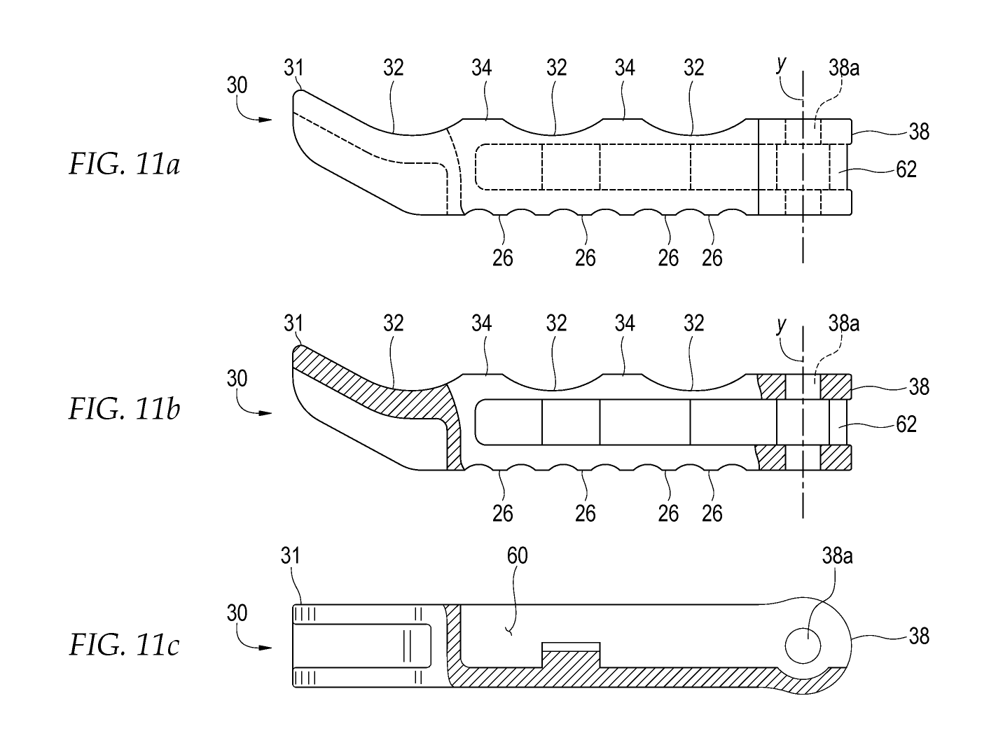

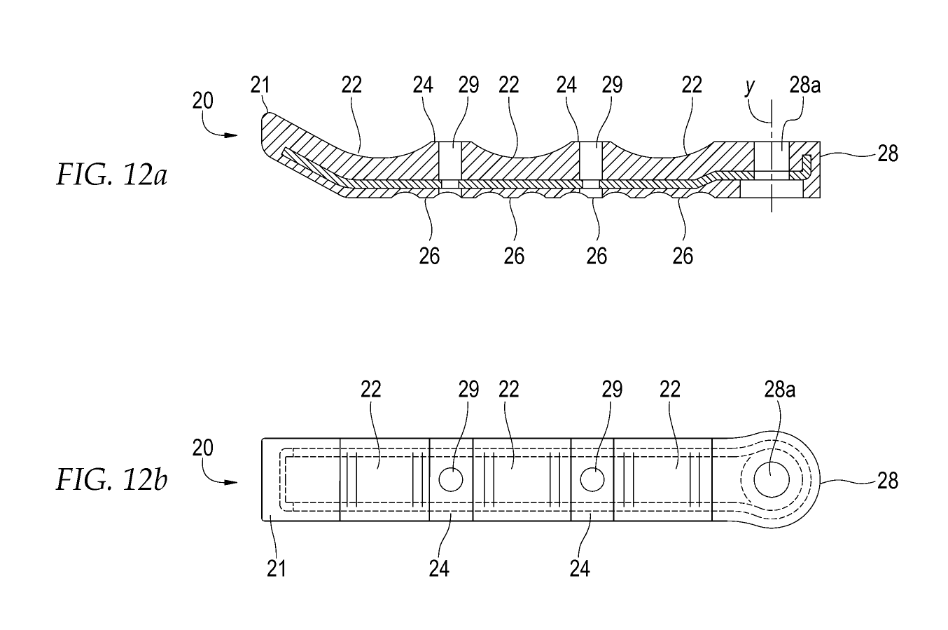

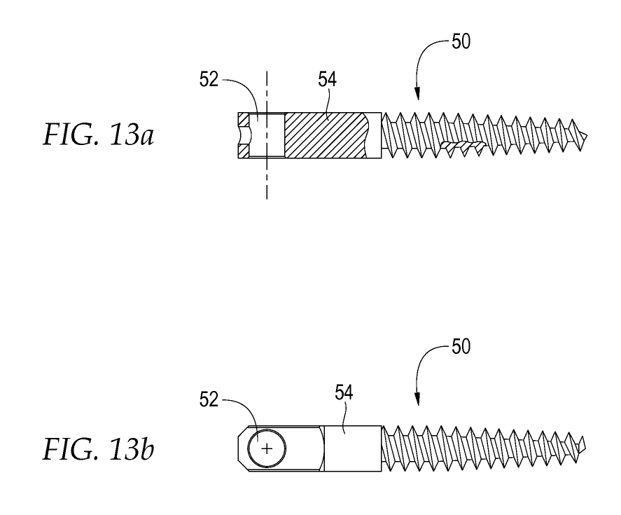

FIGS. 1 through 13b illustrate various views and embodiments of the present invention. In one embodiment, shown in FIGS. 1-10, the hunting accessory 10 comprises three (3) arms 20, 30, 40 and a screw 50, the arms may be configured as an upper arm 20, central arm 30 and lower arm 40. In embodiments having more than three (3) arms, there may be multiple central arms 30. Alternatively, the hunting accessory 10 may comprise only two (2) arms or four (4) or more arms. The arms 20, 30, 40 can be of various lengths but are preferably between 3 and 7 inches in length. The arms 20, 30, 40 can be of varying width, but are preferably between ¼ and 1 ½ inches in width.

As shown in the embodiment shown in FIGS. 1-10, the upper arm 20 and the lower arm 40 may be identical or substantially identical. For example, as shown in FIGS. 1-3 and 5a-5b, the upper arm 20 and lower arm 40 may comprise one or more depressions 22, 42 separated by one or more knobs 24, 44 on their upper surface. These depressions 22, 42 are useful for receiving straps or hooks from articles to be suspended from the upper arm 20 and lower arm 40 (as will be discussed in more detail below). Additionally, the upper arm 20 and lower arm 40 may comprise a plurality of ridges 26, 46 on their lower surface. These ridges 26, 46 create depressions between the crests of the ridges 26, 46 and may serve to offer additional securement for articles suspended from the arms. The arms 20, 40 can be of varying height, but are preferably between ¼ and ¾ inches in height (measured from the knobs 24, 44 to ridges 26, 46). Thus, a user could use the hunting accessory 10 so that the depressions 22, 42 face upward or the ridges 26, 46 face upward, depending on how the user secured it to the tree.

Although in the embodiment shown herein the upper arm 20 and the lower arms 40 are identical, they do not have to be so. The upper arm 20 and lower arm 40 could differ in length, width or have varying configurations/number of depressions 22, 42, knobs 24, 44 and ridges 26, 46. Additionally, the upper arm 20 and the lower arm 40 may comprise one or more openings 29, 49 located on their upper surface. In one embodiment, the openings 29, 49 may not pass completely through the upper arm 20 and lower arm 40 while in another embodiment the openings 29, 49 may pass completely through the upper arm 20 and lower arm 40. The openings 29, 49 may be adapted and/or configured to receive hooks from articles to be suspended from the arms. In one preferred embodiment, the upper and lower arms 20, 40 may also comprise an upwardly angled end 21 which acts to further aid in the securement of articles suspended from the arms.

Additionally, as shown in the embodiment shown in FIGS. 1-11c, the hunting accessory 10 may comprise a central arm 30 positioned between upper arm 20 and lower arm 40. In a similar manner as the upper and lower arms 20, 40, the central arm 30 may comprise a plurality of depressions 32, knobs 34 and ridges 36 which are useful aiding in the suspension and/or securement of articles from or to the central arm 30. Likewise, the central arm 30 may have one or more openings 39 as do the upper arm 20 and lower arm 40. In one preferred embodiment, central arm 30 may also comprise an upwardly angled end 31 which acts to aid in securement of articles suspended from the aims. The central arm 30 may also comprise a cavity or channel located on its bottom edge near its distal end.

In one embodiment, the configuration of the depressions 22,32,42, knobs 24,34,44, ridges 26,36,46 and openings 29, 39, 49 may be identical on the upper arm 20, central arm 30 and lower arms 40. In alternate embodiments, one or more of the upper arm 20, central arm 30, lower arms 40 may have an identical or a different configuration of depressions 22,32,42, knobs 24,34,44, ridges 26,36,46 and/or openings 29, 39, 49 than the others. The central arm 30 can be of varying height, but are preferably between ¼ and ¾ inches in height (measured from the knobs 34 to ridges 36).

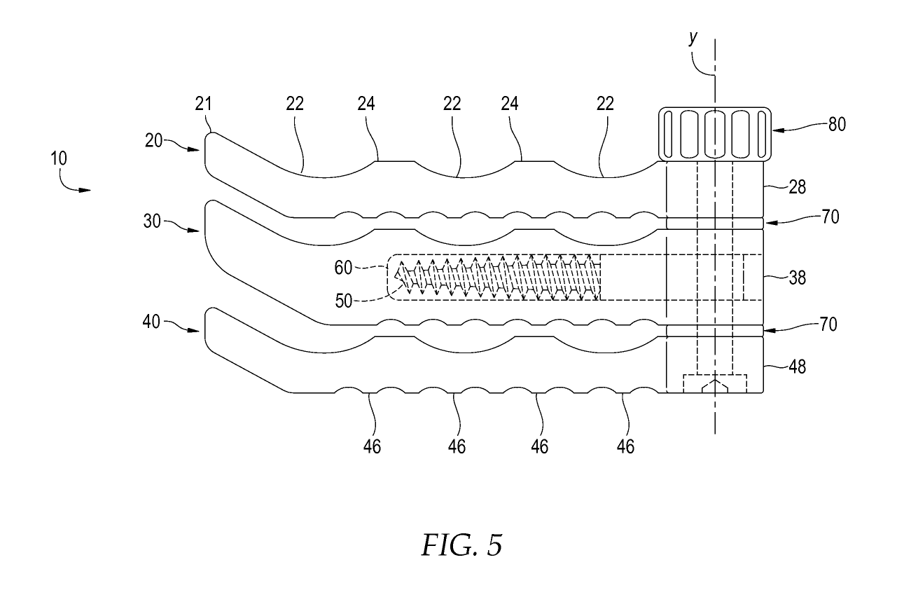

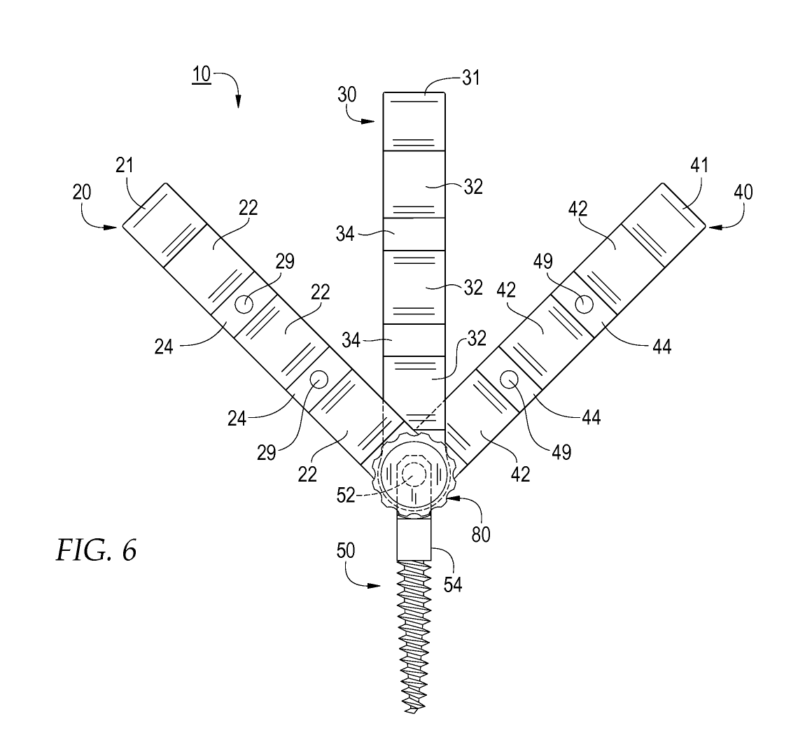

The upper aim 20, central arm 30 and lower min 40 further comprise an attachment point 28, 38, 48 opposite the upwardly angled end 21, 31, 41 which further comprises a central opening 28a, 38a and 48a. The attachment point 28, 38, 48, in one embodiment, is dissected by axis y as shown in FIGS. 1 and 5. The openings 28a, 38a and 48a are adapted and/or configured to receive a bolt, pin, shank, tube (not shown) or other securing mechanism that is oriented parallel to axis y and passes through openings 28a, 38a and 48a. For ease of a reference, the term bolt will be used hereinafter to refer to the securing mechanism. The upper arm 20, central arm 30 and lower arm 40 rotate about or around central axis y. In one embodiment, as shown in FIG. 6, the upper arm 20, central arm 30 and lower arms 40 are independently rotatable about axis y wherein the upper arm 20 may be in a first position, the central arm 30 may be in a second position and the lower arm 40 may be in yet a third position independent of one another. Further, in a preferred embodiment, each of the upper arm 20, central arm 30 and lower arm 40 are freely rotatable three hundred and sixty (360) degrees about axis y. In yet another preferred embodiment, the bolt should freely rotate within central openings 29, 39, 49 without causing the movement of the upper arm 20, central arm 30 and lower arm 40.

The hunting accessory 10 further comprises a screw 50 as depicted in FIGS. 1-6 and 13a-13b. The screw 50 allows the hunting accessory 10 to be secured to a tree or other wooden object (such as a post). The screw 50 may be of varying diameters and length, but it should provide sufficient strength to adequately secure the hunting accessory 10 to the tree after various articles are suspended from the arms 20, 30, 40. In some embodiments, the screw 50 is between ¾ inch to 2 inches, although other lengths can be used. In one embodiment as shown in FIG. 1, the screw 50 may be received into a cavity 60 in the central arm 40 when not in use. This protects the user and equipment from the sharp screw 50 tip. Alternatively in other embodiments (not shown), the screw 50 may be positioned to be received by cavities in either the upper arm 20 or the lower aim 40. In yet an alternate embodiment, the screw 50 may not be housed in a cavity 60 when not in use, but rather may simply be shielded by (i.e., placed above, below, or between) one or more of the arms when not in use. In one embodiment, the cavity 60 does not pass through the entire width of the arm 20, 30, 40 in which it is placed (i.e., a portion of the arm 20, 30, 40 is present to prevent the screw 50 from rotating a full three hundred sixty (360) degrees about the axis y) while in other embodiments the cavity passes through the entire width of the arm 20, 30, 40 in which it is placed and therefore the screw may be able to rotate a full three hundred sixty (360) degrees about the axis y.

In one embodiment, the screw 50 comprises a central screw opening 52 on one end which is adapted and/or configured to receive the same bolt (not shown) that passes through the central openings 29, 39, 49 of the arms. In one embodiment, the screw 50 is independently rotatable from the upper arm 20, central arm 30 and lower arm 40 about axis y. In one embodiment, the screw 50 is not rotatable three hundred and sixty (360) degrees about axis y while in alternate embodiment the screw is rotatable three hundred and sixty (360) degrees about axis y. In one preferred embodiment, the screw 50 moves or rotates about axis y as the bolt is turned as the screw is secured to the bolt via an attachment means such as an Allen screw or other means that would be known to those of ordinary skill in the art. The cavity 60 may define a rear edge 62 proximate to central screw opening 52 such that when the screw 50 is rotated out of the cavity 60 one hundred eighty (180) degrees the screw 50 (or in some embodiments, a portion of a screw head 54) rests against the rear edge 62. The screw can be threaded along its entire length, or as shown in the figures, may have a non-threaded portion. In one embodiment, shown in the figures, the screw 50 may comprises the screw head 54 which is different in cross section than the threaded portion of the screw. In the embodiment shown in the figures, the screw head 54 is rectangular in cross section and contains the central screw opening 52.

The upper arm 20, central arm 30 and lower arms 40 may be separated by one or more washers 70. The washers 70 serve to allow the upper arm 20, central arm 30 and lower arms 40 to better rotate about axis y more easily/with reduced friction as well as provide spacing to prevent the arms 20, 30, 40 from coming into contact one another while in use. Washers 70 are preferred, but not required.

In one embodiment, the hunting accessory 10 may further comprise a top knob 80 which is affixed to one end of the bolt passing through central openings 29, 39, 49 and the screw central opening 52. The top knob 80, in one embodiment, may be sufficiently affixed to the bolt such that as the top knob 80 is moved or turned, the bolt makes a corresponding movement—in other words, in one embodiment, as the top knob 80 is turned, the bolt turns as well. In one preferred embodiment where the screw 50 is affixed or secured to the bolt, turning the top knob 80 moves the screw 50 about axis y and in this embodiment, as the top knob 80 is turned the screw 50 may be moved into/out of the cavity 60 for use.

Use of the hunting accessory 10 is described below. For example, a hunter in a tree stand may have binoculars, a canteen, game call or other article(s) to which they need quick access. The hunting accessory 10 provides one method of providing such access. By way of non-limiting example, the hunter may turn top knob 80 to move the screw 50 from the cavity 60 such that the screw 50 is exposed. Then the hunter can, by applying sufficient force and pressure to the screw 50, secure the hunting accessory 10 to the tree in a convenient and easy to reach location. The overall height of the combined arms provides for additional torque to assist the user in securing the screw 50 into the tree. The arms 20, 30, 40 may also be extended outwardly and used as handles to allow the hunter to apply even more force to secure the screw 50 into the tree. Upon successfully securing the hunting accessory 10 to the tree, the hunter may move one or more of the upper arm 20, central arm 30 and lower arm 40 about axis y such that the arms 20, 30, 40 are accessible to receive the articles that the hunter desires to suspend from the arms 20, 30, 40. After the hunt is finished, the hunter removes the articles suspended from the arms and removes the screw 50 from the tree. The arms 20, 30, 40 and screw 50 then may be placed in the closed configuration (as shown in FIG. 1) and the hunting accessory 10 placed in the hunter's pocket or backpack for transport. While the invention has been discussed as being useful to hunters, it should be recognized that the accessory 10 can be used for a multitude of users other than hunters, such non-limiting examples include photographers to hold cameras, campers to hang various items, water fowl hunters to hang items at water level and bird watchers to hold their binoculars.

What is claimed is:

1. An hunting accessory comprising:
a. a plurality of arms, each arm with an upper and lower surface further comprising:
i. one or more knobs and one or more depressions on the upper surface and one or more ridges on the lower surface;
ii. an upwardly angled end opposite an attachment point, said attachment point further comprising a central opening, and
iii. wherein the plurality of arms comprise at least one arm located between two (2) other arms, said arm further comprising a cavity for receiving a screw, said screw comprising a central screw opening; and
b. a bolt passing through the plurality of arms' central opening and the central screw opening;
wherein the plurality of arms are independently rotatable three hundred sixty (360) degrees about an axis passing vertically through the bolt.

2. An hunting accessory comprising:
a. one or more arms having a central opening that are rotatable about a vertical axis of the central opening;
b. a screw having a central screw opening and independently rotatable about the vertical axis from the one or more arms; and
c. a securing mechanism passing through the one or more arms central opening and central screw opening.

3. The hunting accessory of claim 2 wherein the one or more arms are independently rotatable about the vertical axis.

4. The hunting accessory of claim 3 wherein the one or more arms are independently rotatable three hundred sixty (360) degrees about the vertical axis.

5. The hunting accessory of claim 2 wherein the number of arms is three (3).

6. The hunting accessory of claim 5 wherein one of the one or more arms comprises a cavity configured to receive the screw.

7. The hunting accessory of claim 6 wherein at least one arm comprises an upper surface, said upper surface further comprising one or more one or more knobs and one or more depressions.

8. The hunting accessory of claim 7 wherein the at least one arm comprises a lower surface, said lower surface comprising one more ridges on the lower surface.

9. The hunting accessory of claim 8 wherein at least two (2) of the one or more arms are substantially identical.

10. The hunting accessory of claim 9 wherein the one or more arms comprise an upwardly angled end opposite an attachment point, said attachment point further comprising the central opening for receiving the securing mechanism.

11. The hunting accessory of claim 10 wherein the one or more arms are freely rotatable three hundred sixty (360) degrees about the vertical axis.

12. The hunting accessory of claim 11 wherein the screw is affixed to the bolt such that as the bolt rotates about the vertical axis, the screw rotates about the vertical axis as well.

13. The hunting accessory of claim 12 wherein the screw is positioned between two (2) of the one or more arms.

14. The hunting accessory of claim 5 wherein the central arm comprises a cavity configured to receive the screw.

15. An hunting accessory comprising:
a. a plurality of arms comprising:
i. an angled end opposite an attachment point, said attachment point further comprising a central opening, and
ii. wherein least one arm comprises a cavity for receiving a screw, said screw comprising a central screw opening; and
b. a securing mechanism passing through the plurality of arms' central opening and the central screw opening;
wherein the plurality of arms are independently rotatable about an axis passing vertically through the securing mechanism.

16. The hunting accessory of claim 15 wherein the arms comprise an upper surface and have one or more knobs and one or more depressions on the upper surface.

17. The hunting accessory of claim 16 wherein the arms comprise a lower surface and have one or more ridges on the lower surface.

18. The hunting accessory of claim 17 wherein the arms wherein the plurality of arms are independently rotatable three hundred sixty (360) degrees about the axis passing vertically through the bolt.

19. The hunting accessory of claim 15 wherein the screw is affixed to the securing mechanism.

20. The hunting accessory of claim 15 wherein the number of arms is three (3) or more.
